(19) United States
(12) Patent Application Publication
(10) Pub. No.: US 2022/0373300 A1
(43) Pub. Date: Nov. 24, 2022

(54) CUSTOM BODY ARMOR

(71) Applicant: Vaheh Golestanian Nemagrdi, Orange, CA (US)

(72) Inventor: Vaheh Golestanian Nemagrdi, Orange, CA (US)

(21) Appl. No.: 17/325,012

(22) Filed: May 19, 2021

(51) Int. Cl. F41H 5/04; G06F 30/10; B33Y 50/00; B22F 10/80

(52) U.S. Cl. CPC F41H 5/0492; F41H 5/0442; G06F 30/10; B33Y 50/00; B22F 10/80

(57) ABSTRACT

A body armor for protecting a part of body against a projectile, the body armor comprising an outer surface, an inner surface, and a plurality of cavities. The inner surface is shaped to fit over the protected body part, and the cavities reduce the armor weight. Additionally the cavities profile can help in stopping projectiles.

### BACKGROUND

Body armors are worn by humans to protect them against bullets. Traditionally there are mainly two types of body armors: soft armors and hard armors. A soft armor is lighter, more flexible, and more readily adaptable armor that accommodates the variety of sizes for different individuals. However, it is designed to provide protection against small-caliber shots such as from handguns or shotgun projectiles. On other hand although some hard armors can protect a wearer from medium to large-caliber guns projectiles, they are typically made of metals and ceramics which are heavy materials, therefore hard body armors tend to be fairly heavy and their usage is mainly limited to protecting torso. In addition hard body armors are not sized and shaped to easily conform to a particular wearer body or part of body, as a result hard body armors usage is generally limited to protecting a wearer torso and it is not ordinarily worn for extended periods.

For the foregoing reasons, there is a need for a body armor that can be made to fit wearer body or part of body, in addition it is light and can protect its wearer against medium to large-caliber guns projectiles and shrapnel from explosions.

### SUMMARY

The following is a summary of the present invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

As discussed above soft armors are flexible and light, but they cannot protect against large caliber guns projectiles. On other hand hard armors can provide more protection, however they are heavier and not that much comfortable to bear. An object of the present invention lies in providing a body armor which can protect its wearer against medium to large-caliber guns projectiles and shrapnel from explosions. In addition another object of the present invention is to define an armor which is light and custom made to different parts of body, therefore an armor made based on this disclosure can provide protection for different portions of the wearer body, and it is possible to wear the armor for long period of time.

In order to achieve the above mentioned objects, embodiments of this invention relate to armors for protecting a part of body against guns bullets and shrapnel from explosions and methods to make said armor. One implementation of the invention is an armor for protecting a part of body against a projectile, said armor comprising: an outer surface; an inner surface wherein the inner surface is shaped to fit over the part of body that should be protected; and one or more layers, in which each layer of the armor comprising a front surface, a back surface, a plurality of lateral surfaces, and a plurality of cavities, wherein in the cavities have cylindrical surfaces. The layers of the armor are stacked and attached to each other, making the armor a consolidated piece. The lateral surfaces of each layer are extending from the front surface to the back surface of the layer, covering the sides of the layer and defining a closed volume for the layer. In this particular embodiment of the present invention, the cavities make a crucial role in making the armor light, also they have their own effect in dampening the projectiles kinetic energy, and diverting bullets. As we discussed above the cavities have cylindrical surfaces which gives the cavities a cylindrical shape, furthermore each cavity has two ends and an axis, in which the ends are located on the front, back, or lateral surface of the cavity layer and the axes of the cavities which lay in the same layer are either substantially perpendicular or parallel to each other.

In certain embodiments of the present invention, the cavities of each layer are arranged in a lattice-like configuration.

In certain embodiments of the present invention, the armor is made of a metal material such as steel, stainless steel, titanium, chrome cobalt, chrome nickel alloys or other type of metals. In certain embodiments, the metal armor can be made by first scanning the part of body that should be protected using a 3D scanner to create a 3D image of the protected area. Then the 3D image is used to virtually design the metal armor, and finally a 3D printing technology for metals is used to 3D print the metal armor based on its design. In other embodiments, the metal armor can be made by first scanning the part of body that should be protected using a 3D scanner to create a 3D image of the protected area. Then the 3D image is used to virtually design the metal armor. The design of the metal armor is used to 3D print a casting model for the body armor out of a casting resin material, and finally the metal armor is shaped via a casting process using the 3D printed casting model. In certain embodiments of the present invention, the outer surface of the metal armor is hardened by means of a case hardening process such as Carburizing, Nitriding, Cyaniding, or similar processes.

In certain embodiments of the present invention, the armor further comprising a panel positioned over the outer surface of the armor. The panel comprising a strike surface, and a rear surface. The rear surface of the panel matches and is bonded to the outer surface of the armor whereby the rear surface of the panel and outer surface of the armor are the same. In some embodiments, the panel is made of a metal material and the strike surface of the panel is covered by a hard layer, wherein the hard layer is comprised of a plurality of hard particles and a bonding coating wherein the hard particles are bonded to each other and the strike surface of the panel by means of electroplating or electro less plating. In some embodiments, the hard particles can be made of ceramic, carbide, diamond particles or other similar hard materials.

Bullets and other type of projectiles pierce a target because of their shape, velocity, kinetic energy, and possible spin. The shape of projectiles such as bullets has a great effect on their drag coefficient, impact speed, and the projectile capability to pierce. Because of pointed shape of bullets, they come into contact with a target on a small area of their tip, thereby creating a big amount of pressure stress concentration on the target, which helps bullets to pierce easier. Impact speed or velocity is defined as the speed of a projectile when it is hitting a target and with kinetic energy of projectiles are one of the reasons why a projectile can pierce, having higher impact speed or kinetic energy make it easier for the projectile to pierce or cause damage to the target. A rifling on a gun barrel twists a fired bullet so it spins as it flies. The spin of the bullet causes the bullet to fly straighter and further in addition on impact the bullet behaves like a drill bit, which means that the spin of bullet can help it to pierce a target. Different embodiments of this invention have features which effect shape, velocity, kinetic energy, and possible spin of projectiles, we will discuss about these features and how they can protect different parts of body from projectiles piercing in DETAILED DESCRIPTION section below.

### BRIEF DESCRIPTION OF THE DRAWINGS

These and other features, aspects, and advantages of the present invention will become better understood with regard to the following description, appended claims, and accompanying drawings where:

FIG. 1a is a front view of an armor worn on a model, protecting torso area of the model;

FIG. 1b is a three dimensional view of the armor (not worn) of FIG. 1a;

FIG. 2 is a cross-section view of a single layer of the armor of FIG. 1a;

FIG. 3 is a cross-section view of the armor of FIG. 1a;

FIG. 4 is a three dimensional view of an armor in accordance with another embodiment of the present invention;

FIG. 5 is front view of an armor in accordance with another embodiment of the present invention;

FIG. 6 is a cross-section view of the armor of FIG. 5;

FIG. 7 is a scanning electron microscope (SEM) image of an armor in accordance with another embodiment of the present invention;

### DETAILED DESCRIPTION

In the SUMMARY section above and in the DETAILED DESCRIPTION, and the CLAIMS below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

In this disclosure two axes, lines or surfaces are called substantially parallel when the angle between them is ±5°, and they are substantially perpendicular when the angle between them is between 85° and 95°.

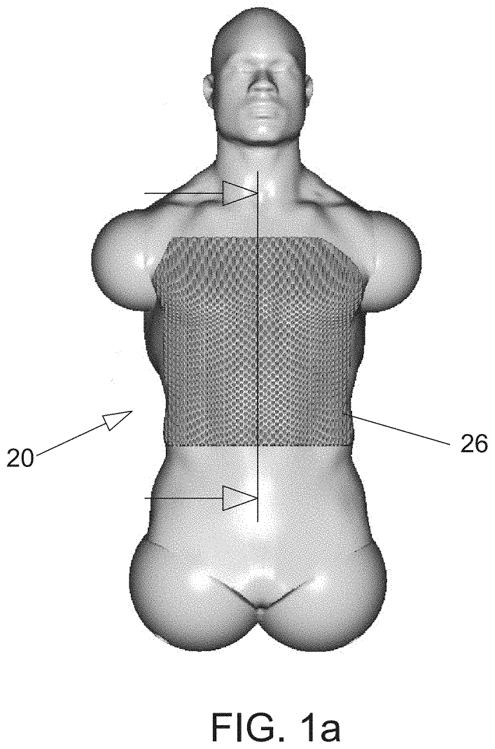

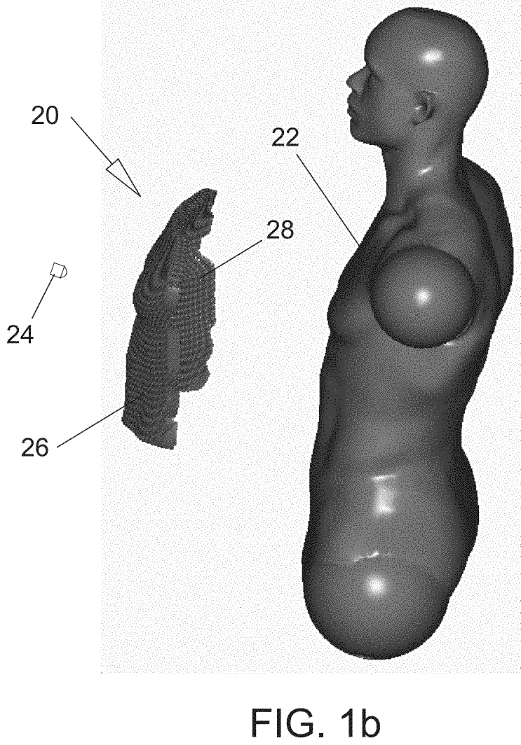

As discussed above the object of the present invention lies in providing a custom made armor which fits over a wearer part of body and can protect it against a projectile, in which the projectile can be a bullet, rock, shrapnel from explosions or similar objects with high kinetic energy which can pierce a person body. FIG. 1a and FIG. 1b show an armor 20 tailored to protect a wearer torso area 22 against a bullet 24 according to certain embodiments of the present invention. Alternatively, the armor can be formed to fit over the wear's limbs, head, neck, back, or other parts of body. The armor 20 compromises an outer surface 26, an inner surface 28, and one or more layers (not indicated in FIG. 1a and FIG. 1b). The inner surface 28 is shaped to fit over the part of body that is intended to be protected, which is torso area 22 in this specific example.

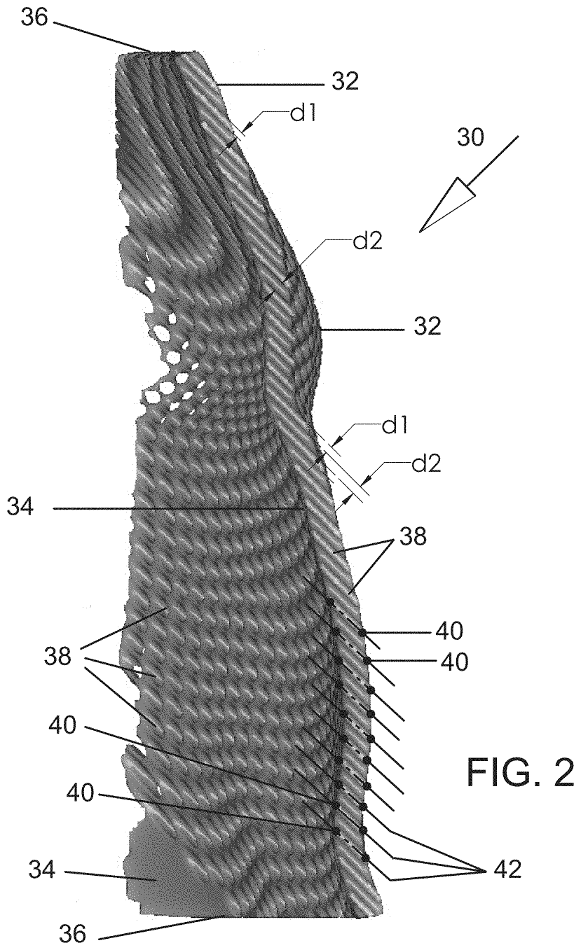

FIG. 2 shows a cross-section view of a typical layer 30 of the armor 20 illustrated in FIG. 1a (the cross-section line is shown in FIG. 1a), the layer 30 comprises a front surface 32, a back surface 34, a plurality of lateral surfaces 36, and a plurality of cavities 38 (not all cavities 38 are indicated). The lateral surfaces 36 of the layer 30 are extending from the front surface 32 to the back surface 34 of the layer 30, covering the sides of the layer 30. The cavities 38 of the layer 30 are passing through the layer 30 creating holes or cavities inside of the layer 30, thereby reducing the total weight of the armor 20, making it lighter and more comfortable for its wearer. In addition the cavities 38 of the layer 30 have cylindrical surfaces, further more each cavity 38 has two ends 40 and an axis 42, in which the ends 40 are located on the front surface 32, or the back surface 34, or the lateral surfaces 36 of the layer 30 (for drawing clarity not all end points 40 and axes 42 are indicated). Moreover, the cavities axes 42 of the layer 30 are either substantially perpendicular or substantially parallel to each other.

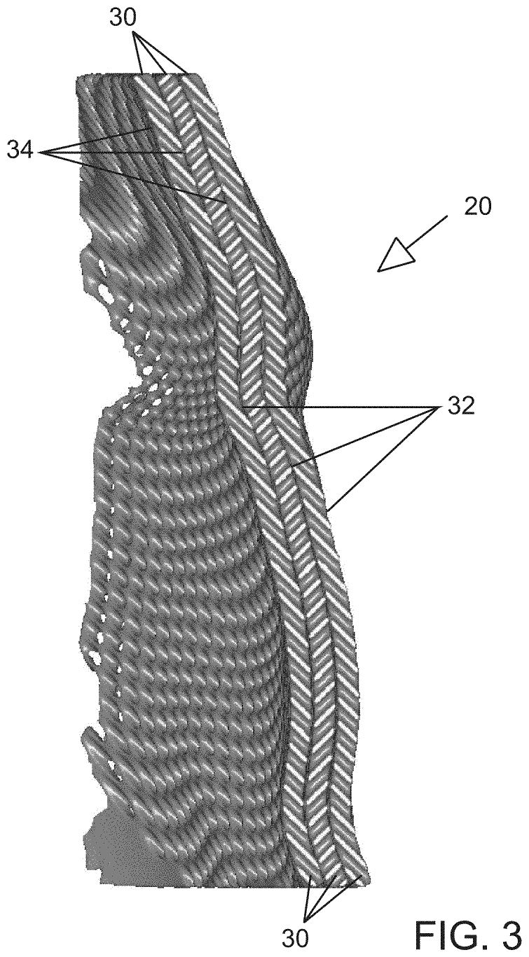

As discussed above an armor based on certain embodiments of the invention can include 1, 2, 3 or more layers. FIG. 3 shows the cross-section view of the armor 20 (the cross section line is shown in FIG. 1a). The layers 30 of the armor 20 are stacked over each other, in which the front surface 32 of each layer 30 can be over the back surface 34 of another contiguous layer whereby contiguous layers 30 of the armor are attached to each other, therefore making the armor a consolidated piece. The attachment of different layers 30 can be created by either making the armor 20 from one piece, or welding layers 30 to each other, or another manufacturing method. In addition when the armor 20 is worn by its wearer, the back surface 34 of any selected layer 30 is positioned closer to the wearer body compared to the front surface 32 of the same layer 30.

The armor cavities 38 make the armor 20 lighter and more comfortable for its wearer to bear it for an extended period of time. In addition cavities 38 can play a role in mitigating stress propagation because the cavities 38 can simply collapse under the projectiles impact, thereby dampening the projectiles velocity and kinetic energy. Furthermore cavities 38 because of their cylindrical surfaces (shapes) are more resistant to piercing (less stress concentration) therefore in this embodiment the cavities 38 play a big role in protecting the body from projectiles. Preferably cavities 38 are small enough to catch small size projectiles and big enough that make the armor 20 light and comfortable to bear. Similarly distances between cavities 38 (d2 shown in FIG. 2) has an effect on the armor 20 weight and level of protection, small distance between cavities (d2) results in lighter armor 20 but lowers the level of protection. Final determination about the cavities diameters (d1 shown in FIG. 2) and the distance between holes (d2) depends on the part of body that the armor is protecting and the type and size of projectiles that the armor is designed to protect from. Generally a diameter (d1) between 2 to 8 mm for cavities 38 and a distance between holes (d2) of 0.5 to 10 mm can achieve the objects mentioned above. Preferably in each layer 30 of the armor, the axes 42 of the cavities 38 make an angle of around 45° with the front surface 32, this can increase the amount of armor material that a possible bullet should pierce before reaching to the body without increasing the weight of the armor.

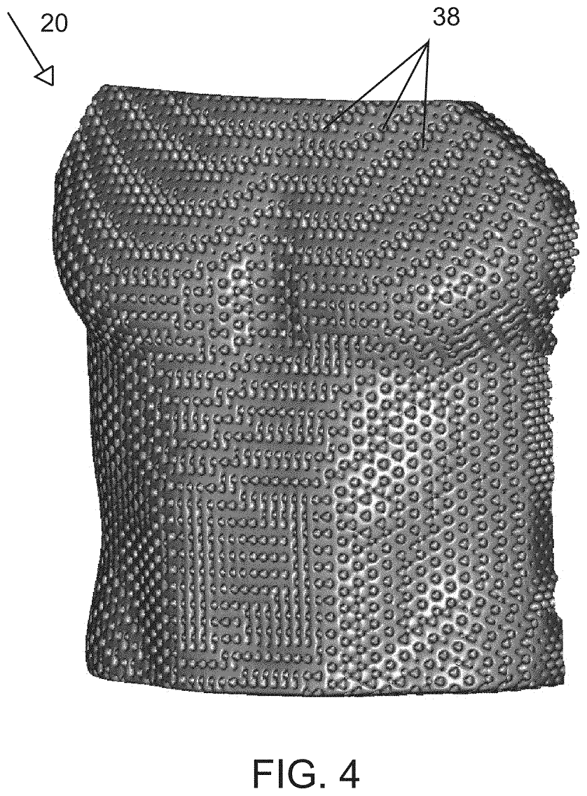

FIG. 4 shows another embodiment of the present invention, wherein the cavities 38 of the armor 20 are arranged in a lattice pattern.

Body armors are generally made of metal or ceramic materials. However, ceramic materials have a brittle nature and therefore they are susceptible to breakage because of projectiles impact. As a result it is not possible to make a one piece consolidated ceramic body armor, they are usually manufactured from different ceramic pieces or particles which are bonded together. An armor 20 based on this disclosure and as described above is preferably made of a metal material such as steel, stainless steel, titanium, chrome cobalt, chrome nickel alloys or other type of metals. This contributes in having an armor 20 which can withstand medium to large-caliber guns projectiles and shrapnel from explosions. In addition through the use of CAD/CAM techniques it is possible to economically manufacture consolidated custom metal armors based on embodiments of this disclosure.

One method of making a metal body armor 20 as described above comprising: scanning the part of body that should be protected, designing the metal armor, and 3D printing of the metal armor. This invention is about a custom body armor in which the inner surface 28 of the armor 20 fits over the body part that the armor 20 is designed to protect from bullets and other projectiles. The geometry of the body part can be determined by scanning it using a 3D scanner such as a laser scanner, blue light scanner, CT scanner or another type of 3D scanner. The purpose of the 3D scanner is to create a point cloud of geometric samples on the scanned body part. Computer aided design (CAD) type software tools and algorithms can be used to convert the point cloud into a digital 3D image of the protected part of body, the digital 3D image can be a CAD file of the scanned part of body comprising 3D information of the scanned portion of the body. Similarly computer aided design (CAD) type software tools may be used to design the armor 20. The result of the design can be a CAD file comprising 3D information of the armor 20. And finally the metal armor 20 is formed using a metal 3D printing technology based on the design of the armor 20. Powder bed fusion 3D printing technology is currently the most common type of metal 3D printing system. In this technology a fine layer of metal powder is distributed over a build plate and selectively melt across section of the design into the powder layer. When the armor is 3D printed it may need to be cleaned from excessive powder. All cavities 38 have a passage to the outside of their layer 30, also the preferred diameter (d1) for cavities 38 is between 2 and 8 mm, these features make it simple to clean possible stuck metal powder in the cavities 38.

Another method of making the metal armor as described above comprising: scanning the part of body that should be protected, designing the metal armor, 3D printing a casting model, forming of the metal armor via a casting process. The geometry of the part of body that should be protected is determined by scanning it using a 3D scanner such as a laser scanner, blue light scanner, CT scanner or another type of 3D scanner. The 3D scanner creates a point cloud of the scanned body part. A computer aided design (CAD) software can be used to make a virtual digital 3D image of the protected part of body out of the point cloud, the digital 3D image can be in a CAD file format, wherein the CAD file comprising 3D information of the scanned portion of the body. Similarly computer aided design (CAD) type software tools may be used to design the armor 20 in a computer. The result of the design can be a CAD file comprising 3D information of the armor 20. The design of the armor 20 is used to 3D print a casting model via a 3D printing technology, wherein the casting model is 3D printed out of a casting resin material, and finally the metal armor 20 is formed via a casting process using the 3D printed casting model.

In certain embodiments of the present invention, the outer surface 26 of the metal armor 20 is hardened by means of a case hardening process such as Carburizing, Nitriding, Cyaniding, or similar processes. The case hardened outer surface 26 of the metal armor 20 act in deforming the nose cone of a bullet. The deformation caused by the case hardened outer surface 26 increases the surface of impact whereby preventing the bullet from piercing the metal armor 20.

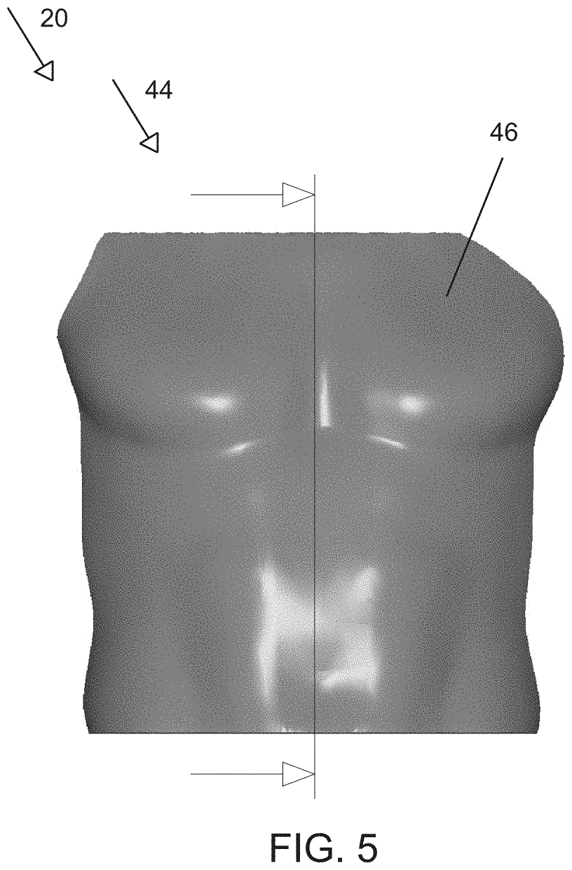

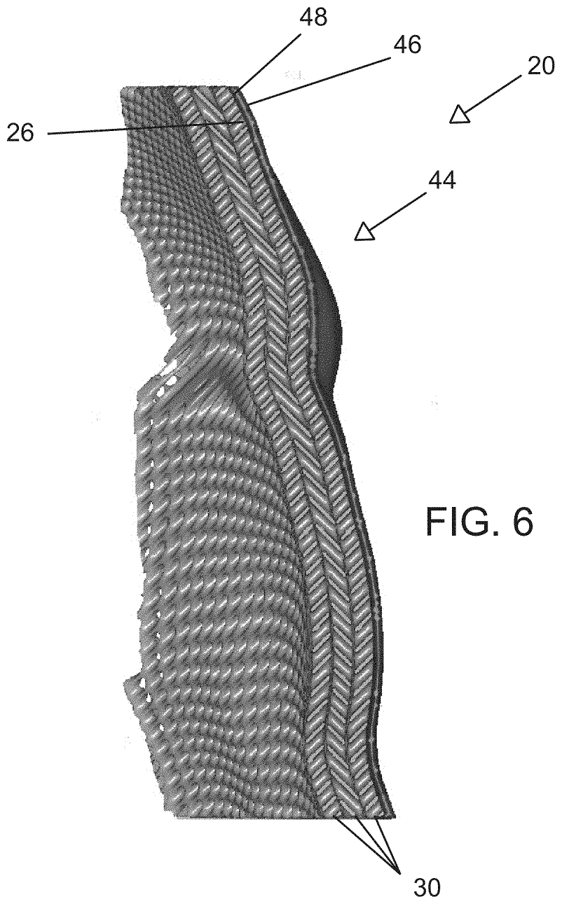

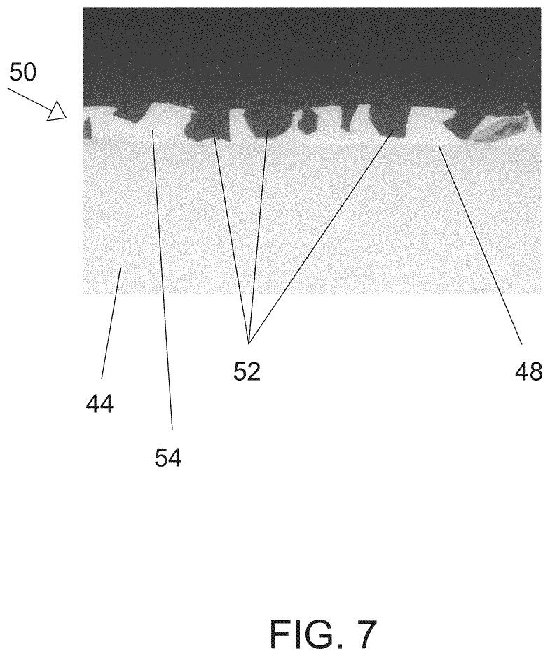

FIG. 5 and FIG. 6 show another embodiment of the present invention, as it is shown in certain embodiments of the present invention the armor 20 further comprising a panel 44, wherein the panel 44 comprising a strike surface 46 and a rear surface 48. The panel 44 does not necessarily refer to a planar or rectangular piece, it can have various shapes. However the rear surface 48 of the panel 44 and outer surface 26 of the armor 20 are the same, thereby the panel 44 is bonded to the rest of the armor, making the armor 20 a consolidated piece. FIG. 7 shows a scanning electron microscope (SEM) image of the armor 20, according to FIG. 7 in certain embodiments of the present invention the strike surface 48 of panel 44 is covered by a hard layer 50, wherein the hard layer 50 includes a plurality of hard particles 52 such as diamond, carbide, ceramic or similar hard materials. The hard particles are bonded to the strike surface 48 and each other by means of a bonding coating 54 created by an electroplating or electro less plating process. The hard particles 52 of the hard layer 50 act in deforming a bullet nose cone, thereby increasing the bullet impact surface which helps in stopping the bullet.

Although the present invention has been described in connection with preferred embodiments thereof, it will be appreciated by those skilled in the art that additions, deletions, modifications, and substitution not specifically described may be made without department from the spirit of the invention as defined in the appended claims.

What is claimed is:

1. An armor for protecting a part of body against a projectile, the armor comprising:
(a) an outer surface;
(b) an inner surface wherein the inner surface of the armor is shaped to fit over the protected part of body; and
(c) one or more layers in which each layer of the armor comprising a front surface, a back surface, a plurality of lateral surfaces, and a plurality of cylindrical cavities, wherein the layers are stacked and attached to each other making the armor a consolidated body, the lateral surfaces of each layer extending from the front surface to the back surface of the layer, and each cavity comprising two ends and an axis, in which the ends are located on the front, back, or lateral surfaces of the cavity layer, wherein the axes of the cavities of each layer are either substantially perpendicular or substantially parallel to each other.

2. The armor as defined in claim 1 wherein the cavities of each layer are arranged in a lattice-like configuration.

3. The armor as defined in claim 1 wherein the armor is made of a metal material.

4. The armor as defined in claim 3 wherein the outer surface of the armor is hardened by means of a case-hardening process.

5. A method of making the armor as defined in claim 3 comprising the steps of:
(a) obtaining a 3D image of the protected part of body using a 3D scanning system;
(b) designing the armor as defined in claim 3 on a computer, wherein the designing is based on the 3D image of the body part; and
(c) forming of the metal armor via a 3D printing technology for metals based on the armor design created in step (b).

6. A method of making the armor as defined in claim 3 comprising the steps of:
(a) obtaining a 3D image of the protected part of body using a 3D scanning system;
(b) designing the armor as defined in claim 3 on a computer, wherein the designing is based on the 3D image of the body part;
(c) manufacturing a casting model for the armor based on the armor design created in step (b) via a 3D printing technology, wherein the casting model is 3D printed out of a casting resin material; and
(d) forming of the metal armor via a casting process using the casting model manufactured in step (c).

7. The armor as defined in claim 1, further comprising a panel positioned over the outer surface of the armor, wherein the panel comprising a strike surface, and a rear surface, wherein the rear surface of the panel matches and is bonded to the outer surface of the armor.

8. The armor as defined in claim 7, wherein the panel is made of a metal material and the armor further comprising a hard layer in which the hard layer covers the strike surface of the panel, and the hard layer comprising a plurality of hard particles and a bonding coating, wherein the hard particles are bonded to each other and the strike surface of the panel by means of the bonding coating created by an electroplating or electro less plating process.

9. The armor as defined in claim 8 wherein the hard particles are made of a material selected from the group consisting of diamond, ceramic, and carbide.
